(19) United States
(12) Patent Application Publication
(10) Pub. No.: US 2006/0171729 A1
(43) Pub. Date: Aug. 3, 2006

(54) Multicolor image forming apparatus to prevent color contamination

(76) Inventors: Hisao Okada, Suwon-si (KR); So-Won Sheen, Seoul (KR); Jong-Moon Eun, Suwon-si (KR)

Correspondence Address: STANZIONE & KIM, LLP, 919 18TH STREET, N.W., SUITE 440, WASHINGTON, DC, 20006, US

(21) Appl. No.: 11/337,548

(22) Filed: Jan. 24, 2006

(30) Foreign Application Priority Data
Feb. 2, 2005 (KR) 2005-9732

(51) Int. Cl. G03G 15/01; G03G 15/06

(52) U.S. Cl. 399/55; 399/223

(57) ABSTRACT

A multicolor image forming apparatus includes a plurality of developing units and a development power supply unit. Each of the developing units includes a developing roller located at a development gap from a photosensitive body, deposits toner accommodated therein on a surface of the developing roller, and supplies the toner to the photosensitive body across the development gap. The development power supply unit applies a development bias voltage to developing rollers of the developing units, the developing bias voltage being a rectangular AC bias voltage in which a forward bias voltage and a reverse bias voltage alternate. A percentage of toner particles of the toner having diameter-charge amounts greater than a contamination limit diameter-charge amount of a toner particle is less than 5%.

### CROSS-REFERENCE TO RELATED APPLICATIONS

This application claims the benefit under 35 U.S.C. § 119 of Korean Patent Application No. 2005-9732, filed on Feb. 2, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, such as a copier, a facsimile apparatus, and a printer, and more particularly, to a multicolor image forming apparatus to form a multicolor image by developing a plurality of electrostatic images to form one or more toner images having different colors on a photosensitive body and then transferring the toner images onto a transfer medium.

2. Description of the Related Art

In conventional multicolor image forming apparatuses for forming a multicolor image, a plurality of toner images having different colors are sequentially developed on a photosensitive body, and then the toner images are transferred on a sheet of paper. In the conventional multicolor image forming apparatuses, the already developed toner images should not be altered when other toner images are developed on the photosensitive body.

The toner image alteration can be prevented by employing a well-known non-contact developing method using one-component nonmagnetic toner, in which high-quality color images can be obtained and a small developing apparatus can be manufactured with low costs. Japanese Patent Publication No. 6-70727 (Japanese Patent Laid-Open Publication No. 1989-134475) and Japanese Patent Publication No. 7-82267 (Japanese Patent Laid-Open Publication No. 1988-139379) disclose non-contact developing apparatuses using a DC development bias voltage. The non-contact developing apparatuses use toner having an extremely small charge amount of 3 micro Coulomb/gram. Although the toner used has the extremely small charge amount, each of the non-contact developing apparatuses a toner image with a sufficient image density on a photosensitive body by supplying a sufficient amount of the toner to the photosensitive body. Also, the non-contact developing apparatuses do not alter or color-contaminate the toner images already formed on the photosensitive body. However, the non-contact developing apparatuses are disadvantageous in that fine lines cannot be printed.

Also, Japanese Patent Publication No. 3357418 (Japanese Patent Laid-Open Publication No. 1994-242657) discloses a developing apparatus using an AC bias voltage of a square waveform as a development bias voltage, and a method of setting the AC bias voltage or a time required to apply the AC bias voltage such that a toner image already formed on a photosensitive body is not separated from the photosensitive body or contaminated by other colors. The method is based on a theoretical analysis of a movement of toner. That is, experimental tests have shown that preventing the color contamination of the toner image already formed on the photosensitive body and obtaining an appropriate image density of the toner image cannot be simultaneously accomplished.

### SUMMARY OF THE INVENTION

The present general inventive concept provides a multicolor image forming apparatus to form a multicolor image by developing a plurality of toner images having different colors on a photosensitive body and then simultaneously transferring the plurality of toner images onto a transfer medium.

The present general inventive concept also provides a multicolor image forming apparatus which does not alter a toner image already formed on a photosensitive body, reduces an unwanted color mixture, and develops a multicolor image having an appropriate image density.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a multicolor image forming apparatus to print a multicolor image by sequentially developing a plurality of toner images of different colors on a photosensitive body and simultaneously transferring the toner images onto a transfer medium, the multicolor image forming apparatus including a plurality of developing units and a development power supply unit. Each of the developing units includes a developing roller having a development gap with the photosensitive body to have toner coated on a surface thereof and to supply the toner to the photosensitive body across the development gap. The development power supply unit applies a development bias voltage to the developing rollers of the plurality of developing units. The developing bias voltage is a rectangular AC bias voltage in which a forward bias voltage and a reverse bias voltage alternate. A percentage of toner particles contained in the toner and having diameter-charge amounts greater than a contamination limit diameter-charge amount Q_{CL}, is less than 5%. The contamination limit diameter-charge amount Q_{CL} denotes a lower limit of a charge amount of a toner particle depending on a diameter of the toner particle so that the toner particle flies from the developing roller to a first region of the photosensitive body occupied by a first toner image, and the contamination limit diameter-charge amount Q_{CL} is calculated using variables including the forward bias voltage, a duration of the forward bias voltage, the reverse bias voltage, a width of the development gap, and a first potential of the first region on the photosensitive body already occupied with the first toner image.

A percentage of toner particles having a diameter-charge amount between the contamination limit diameter-charge amount Q_{CL} and a development limit diameter-charge amount Q_{DL} may be more than 45%. The development limit diameter-charge amount Q_{DL} denotes a lower limit of a charge amount of a toner particle depending on a diameter thereof so that the toner particle can be transferred from the developing roller to the photosensitive body, and the development limit diameter-charge amount Q_{DL} is calculated using variables including the forward bias voltage, the duration thereof, the reverse bias voltage, the width of the development gap, the first potential of the first region on the photosensitive body already occupied with the first toner image, and a second potential of a second region on the photosensitive body where a second toner image is to be developed.

The foregoing and/or other aspects of the present general inventive concept may also be achieved by providing a multicolor image forming apparatus to print a multicolor image by developing and overlapping a plurality of toner images of different colors on a photosensitive body and transferring the toner images onto a transfer medium, the multicolor image forming apparatus including a plurality of developing units each including a developing roller located at a development gap from the photosensitive body to have toner coated on a surface thereof, and to supply the toner to the photosensitive body across the development gap, and a development power supply unit to apply a development bias voltage to the developing rollers of the plurality of developing units. The development bias voltage is a rectangular AC bias voltage in which a forward bias voltage and a reverse bias voltage alternate. The development bias voltage is determined such that a percentage of toner particles contained in the toner and having diameter-charge amounts greater than a contamination limit diameter-charge amount of a toner particle, Q_{CL}, is less than 5%. The contamination limit diameter-charge amount Q_{CL} denotes a lower limit charge amount of a toner particle depending on a diameter thereof, with respect to a limit of charge amounts of second toner particles of a second toner image so that the toner particle adheres to a region on the photosensitive body occupied by a first toner image, and the contamination limit diameter-charge amount of a toner particle Q_{CL} is calculated using variables including the forward bias voltage, a duration of the forward bias voltage, the reverse bias voltage, a width of the development gap, and a potential of the region on the photosensitive body already occupied with the first toner image.

The foregoing and/or other aspects of the present general inventive concept may also be achieved by providing a multicolor image forming apparatus to print a multicolor image by developing a plurality of toner images of different colors on a photosensitive body and transferring the toner images onto a transfer medium, the multicolor image forming apparatus including a plurality of developing units and a development power supply unit. Each of the developing units includes a developing roller located at a development gap from the photosensitive body to have toners coated on a surface thereof, and to supply the toners to the photosensitive body across the development gap. The development power supply unit applies a development bias voltage to the developing rollers of the plurality of developing units. The development bias voltage is a rectangular AC bias voltage. A percentage of toner particles contained in the toners and having diameter-charge amounts greater than a contamination limit diameter-charge amount is less than 5%. The contamination limit diameter-charge amount is a limit of a charge amount of a toner particle depending on a diameter thereof, so that the toner particle adheres to a region on the photosensitive body occupied by a first toner image when the development bias voltage is applied.

A percentage by toner particles contained in the toner area having diameter-charge amounts between the contamination limit diameter-charge amount and a development limit diameter-charge amount may be more than 45%. The development limit diameter-charge amount is a limit of a charge amount of a toner particle depending on a diameter thereof, so that the toner particle flies from the developing roller to an electrostatic latent image formed on the photosensitive body by the development bias voltage.

The foregoing and/or other aspects of the present general inventive concept may also be achieved by providing a multicolor image forming apparatus to print a multicolor image by developing and overlapping a plurality of toner images of different colors on a photosensitive body and transferring the toner images onto a transfer medium, the multicolor image forming apparatus including a plurality of developing units and a development power supply unit. Each of the developing units includes a developing roller located at a development gap from the photosensitive body such that toners accommodated therein is coated on a surface of the developing roller, and supplied to the development gap. The development power supply unit applies a development bias voltage to the developing rollers of the developing units. The development bias voltage is a rectangular AC bias voltage. The development bias voltage is determined such that a percentage of toner particles contained in the toner and having diameter-charge amounts greater than a contamination limit diameter-charge amount of the toner particles is less than 5%. The contamination limit diameter-charge amount denotes a limit of a charge amount of a toner particle depending on a diameter thereof, with respect to a limit of charge amounts of second toner particles of a second toner image so that the toner particle adheres to a region on the photosensitive body occupied by a first toner image.

The foregoing and/or other aspects of the present general inventive concept are also achieved by providing a multicolor image forming apparatus comprising a photosensitive body to form a first color latent image, and a developing unit spaced apart from the photosensitive body by a gap to develop the first color latent image with a toner having toner particles to form a first toner color image on a first region of the photosensitive body according to a first potential having a first forward bias voltage and a first reverse bias voltage, wherein a portion of the toner particles having a diameter-charge amount greater than a contamination limit diameter-charge amount which is determined according to first variables having the forward bias voltage, a duration of the forward bias voltage, the reverse bias voltage, the gap, and a potential of the first region, is less than 5% with respect to a total amount of the toner particles of the toner.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a structure of a multicolor image forming apparatus according to an embodiment of the present general inventive concept;

FIG. 2 illustrates a development bias voltage applied to a developer roller of the apparatus of FIG. 1;

FIG. 3A illustrates a surface potential profile of a photosensitive body of the apparatus of FIG. 1 when a first color toner image is developed;

FIG. 3B illustrates a surface potential profile of the photosensitive body of the apparatus of FIG. 1 when a second color toner image is developed;

FIG. 4A is a graph illustrating a toner motion (flying or transferring distance) between a developing unit and the photosensitive body of the apparatus of FIG. 1, and FIG. 4B is a graph illustrating a development bias voltage to be applied to the developing roller of the apparatus of FIG. 1;

FIG. 5 is a graph of a forward bias voltage versus duration time of applying the forward bias voltage for equal to illustrate flying heights or distances of toner used in the apparatus of FIG. 1;

FIG. 6 is a graph of the forward bias voltage versus duration time to illustrate differences between the flying heights or distances of the toner particles towards the non-development region and the development region of the photosensitive body of the apparatus of FIG. 1;

FIG. 7 is a graph illustrating a charge-diameter distribution of toner particles between a charge development limit curve and a charge contamination limit curve for the apparatus of FIG. 1;

FIGS. 8A, 8B, 8C, and 8D illustrate results of a motion simulation of toner particles having a uniform charge amount and a uniform particle diameter to move towards the photosensitive body of the apparatus of FIG. 1;

FIG. 9 is a graph illustrating a wide charge-diameter distribution of toner particles that are used in the apparatus of FIG. 1;

FIGS. 10A, 10B, and 10C illustrate results of a motion simulation of the toner particles having the wide charge-diameter distribution illustrated in FIG. 9;

FIG. 11 is a graph illustrating a narrow charge-diameter distribution of toner particles that are used in the apparatus of FIG. 1;

FIGS. 12A, 12B, and 12C illustrate results of a motion simulation of the toner particles having the narrow charge-diameter distribution illustrated in FIG. 11;

FIG. 13 illustrates a structure of a developing unit of the multicolor image forming apparatus of FIG. 1, according to an embodiment of the present general inventive concept;

FIG. 14 illustrates a structure of a developing unit of the multicolor image forming apparatus of FIG. 1, according to another embodiment of the present general inventive concept;

FIG. 15 illustrates a structure of a developing unit used in the multicolor image forming apparatus of FIG. 1, according to another embodiment of the present general inventive concept; and

FIGS. 16A and 16B illustrate a degree of color contamination which varies according to a development order.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

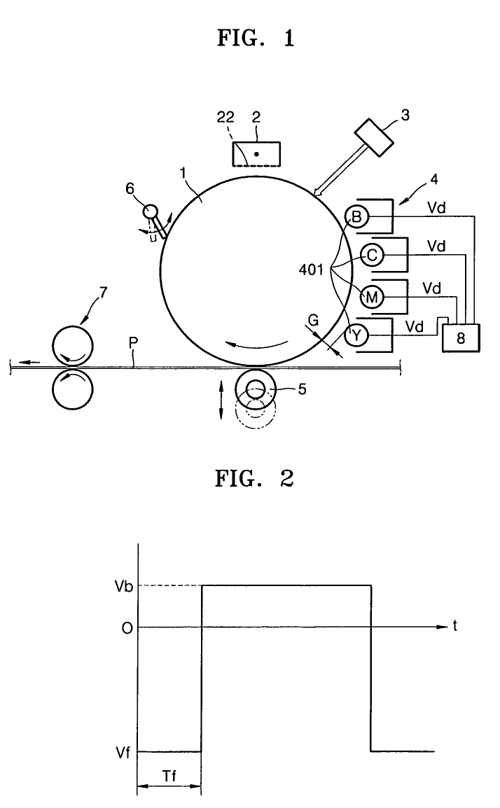

FIG. 1 illustrates a structure of a multicolor image forming apparatus according to an embodiment of the present general inventive concept. A scorotron charger 2, an exposing unit 3, a plurality of developing units 4, a transfer roller 5, and a cleaning unit 6 are arranged around a photosensitive body 1 in a clockwise direction. In the present embodiment, the photosensitive body 1 may be a photosensitive drum formed by coating a surface of a metallic pipe with a photosensitive layer. However, it should be understood that the present general inventive concept is not intended to be limited to the photosensitive drum as the photosensitive body 1, and that the multicolor image forming apparatus may include other embodiments of the photosensitive body 1. For example, alternatively, a photosensitive belt that circulates may be used as the photosensitive body 1. The scorotron charger 2 is an example of a charging unit to charge a surface of the photosensitive body 1 with a uniform potential. The scorotron charger 2 includes a grid electrode 22. The uniform potential can be adjusted by adjusting a grid voltage applied to the grid electrode 22. The exposing unit 3 irradiates light modulated according to image information, to the photosensitive body 1 to form an electrostatic latent image. The exposing unit 3 may be a laser scanning unit (LSU) using a laser diode as a light source.

Black (B), cyan (C), magenta (M) and yellow (Y) color toners may be respectively accommodated in corresponding ones of the plurality of developing units 4. However, it should be understood that the present general inventive concept is not intended to be limited to four color toners or to the above mentioned color combination. The present general inventive concept may be applied whenever one or more different color toners are used. The above color combination is used for convenience of the following explanation, since image forming apparatuses frequently use this color combination. Each of the plurality of developing units 4 includes a developing roller 401. The plurality of the developing units 4 are arranged such that the developing rollers 401 are spaced apart from the photosensitive body 1 by a development gap (G). Charging polarities of the color toners accommodated in the plurality of the developing units 4 and are equal to that of the photosensitive body 1 such that an electric force makes toner particles to fly from the developing rollers to the photosensitive body 1. A development bias voltage (Vd) supplied from a development power supply unit 8 is applied to the developing rollers 401 such that the transferred toner particles adhere to the electrostatic latent image on the photosensitive body 1. The toner may include toner particles and other components. The toner particles and some of the other components may fly from the developing roller 401 to the photosensitive body 1 through the development gap (G). The toner particles and some of the other components attached to the toner particles can be collectively called toner particles.

A sheet of paper (P) (or other transfer medium) may be conveyed between the photosensitive body 1 and the transfer roller 5. The transfer roller 5 is an embodiment of a transfer unit to transfer the color toners adhering to the photosensitive body 1 to the paper (P). A transfer bias potential may be applied to the transfer roller 5. However, it should be understood that the present general inventive concept is not intended to be limited to the transfer roller 5 as the transfer unit and the multicolor image forming apparatus may include other embodiments of the transfer unit. For example, the transfer unit may be a corona discharger. The cleaning unit 6 removes the color toners remaining on the surface of the photosensitive body 1 after an operation of transferring the color toners onto the paper (P).

A multicolor image printing process performed by the multicolor image forming apparatus of FIG. 1 will be described. First, the surface of the photosensitive body 1 is charged with a uniform potential by the scorotron charger 2. Then, light modulated according to the image information about first image of a first color (for example, black) is irradiated to the photosensitive body 1 by the exposing unit 3 to form a first electrostatic latent image of the first color on the photosensitive body 1. A first color toner supplied by one of the plurality of developing units 4 adheres to the photosensitive body 1 according to the first electrostatic latent image of the first color, so that a first color toner image is formed on the photosensitive body 1. Before a front end of the first color toner image reaches the transfer roller 5 when the photosensitive body 1 rotates clockwise, the transfer roller 5 is retreated (disposed) to a location where the transfer roller 5 does not contact the photosensitive body 1. In addition, the cleaning unit 6 is retreated (disposed) to a location where the cleaning unit does not contact and potentially alter the first color toner image formed on the photosensitive body 1.

Next, the scorotron charger 2 charges again the photosensitive body 1. The exposing unit 3 irradiates light modulated according to image information about a second image of a second color to the photosensitive body 1 to form a second electrostatic latent image of the second color on the photosensitive body 1. A second color toner supplied by a second one of the plurality of developing units 4 adheres to the photosensitive body 1 according to the second electrostatic latent image of the second color, so that a second toner image is formed on the photosensitive body 1. Then, a two-color toner image is formed by overlapping the first and the second toner images of the first and second colors on the photosensitive body 1.

When the above-mentioned processes are performed for third and fourth color toners, the toner images of the first, second, third, and fourth colors are formed on the photosensitive body 1, thereby forming a multicolor toner image. A leading end of the paper (P) reaches a transfer nip where the photosensitive body 1 and the transfer roller 5 face each other, when the leading end of the multicolor toner image reaches the transfer nip. An electric field due to the transfer bias potential is generated on a rear surface of the paper P. At this time, the transfer roller 5 is moved close to the photosensitive body 1 to assure that the paper (P) is in contact with the photosensitive body 1. The multicolor toner image is then transferred to the paper (P). A fixing unit 7 applies heat and pressure to the multicolor toner image to fix the multicolor toner image onto the paper (P). Then, the cleaning unit 6 is moved to be in contact with the photosensitive body 1, so that after the transfer process is performed, the color toners remaining on the photosensitive body 1 are removed by the cleaning unit 6.

When developing the color toner images on the photosensitive body 1, a toner image already developed on the photosensitive body 1 should not be agitated (altered, changed or contaminated) when the other color toner images are developed. Also, the toner image already developed on the photosensitive body 1 should not be contaminated by the other color toners. The multicolor toner image is printed by developing and overlapping cyan (C), magenta (M), yellow (Y) and black (B) color toner images. Color contamination means development of the other toner images on other regions other than regions where the other toner images should be developed after the first toner image has been formed. Agitation (alteration) of a color toner image developed on the photosensitive body 1 due to mechanical contact between the photosensitive body 1 and the developing rollers 401 can be overcome by using a non-contact developing method in which the photosensitive body 1 is spaced from the developing roller 401 by the development gap (G).

In order to prevent the color of the toner image already developed on the photosensitive body 1 from being contaminated by other colors of the other color toner images when the other color toner images are developed on the photosensitive body 1, a suitable development bias voltage (Vd) should be applied to the developing rollers 401. The development bias voltage (Vd) can be an AC bias voltage having a square waveform as illustrated in FIG. 2. A forward bias voltage (Vf) is a bias voltage to move the toner from the developing roller 401 to the photosensitive body 1, and a reverse bias voltage (Vb) is a bias voltage to move the toner from the photosensitive body 1 to the developing roller 401. In order to solve the color contamination problem, the forward bias voltage (Vf) and a time duration (Tf) thereof need to be adjusted. A time period (duration) of the forward bias voltage (Vf) may be changed (determined) according to the time duration (Tf).

Equations 1, 2, 3 and 4 are used in the present embodiment to obtain conditions to avoid the color contamination and to obtain a sufficient image density.

$$Equation 1 \\ {Q}_{CL} = \frac{3 π D η G}{{E}_{p 2} ( {T}_{p 2} - {T}_{f} ) + {E}_{p 1} {T}_{f}} \\ {T}_{p 2} = - \frac{m}{3 π D η} ln [ \frac{{E}_{p 2} exp ( - \frac{3 π {DT}_{f}}{m} )}{{E}_{p 2} - {E}_{p 1} ( 1 - exp ( - \frac{3 π {DT}_{f}}{m} ) )} ] \qquad \begin{matrix} \\ ( 1 )\end{matrix}$$

where Q_{CL} is a contamination limit charge amount of a toner particle depending on a diameter D of the toner particle, m is the mass of the toner particle, η is a viscosity of air, G is a width of the development gap, Vf is the forward bias voltage, Vb is the reverse bias voltage, Tf is the duration Tf of Vf, Vp is a first potential of a first region on the photosensitive body 1 that is already occupied by a toner image, Eₚ₁(=(Vf−Vp)/G) is a forward electric field generated in the first region of the photosensitive body 1 already occupied by a toner image, and Eₚ₂(=(Vb−Vp)/G) is a reverse electric field generated in the first region of the photosensitive body 1 already occupied by a toner image.

$$Equation 2 \\ {Q}_{DL} = \frac{3 π D η G}{{E}_{i 2} ( {T}_{i 2} - {T}_{f} ) + {E}_{i 1} {T}_{f}} \\ {T}_{i 2} = - \frac{m}{3 π D η} Ln [ \frac{{E}_{i 2} exp ( - \frac{3 π D η {T}_{f}}{m} )}{{E}_{i 2} - {E}_{i 1} ( 1 - exp ( - \frac{3 π D η {T}_{f}}{m} ) )} ] \qquad \begin{matrix} \\ ( 2 )\end{matrix}$$

where Q_{DL} is a development limit charge amount of a toner particle depending on the diameter of the toner particle, Vi is a second potential of a second region on the photosensitive body 1 on which the next color images will be developed after the first color toner image, Eᵢ₁(=(Vf−Vi)/G) is a forward electric field generated in the second region on which the next color images will be developed after the first color toner image, and Eᵢ₂ (=(Vb−Vi)/G) is a reverse electric field generated in the second region on which the next color images will be developed after the first color toner image.

$$Equation 3$$

$$m \frac{{ⅆ}^{2} H}{ⅆ {t}^{2}} = QE - 3 π D η \frac{ⅆ H}{ⅆ t} Δ ( ɛ E ) = 0 \qquad ( 3 )$$

where H is a location of a toner particle, Q is a charge amount of the toner particle, E is an electric field (which is equal to (Vpc−Vd)/G), Vpc is the surface potential of the photosensitive body 1, and Vd is the development bias voltage, and ε is the air permittivity.

$$Equation 4 \begin{matrix}{m}_{i} \frac{{ⅆ}^{2} {H}_{i}}{ⅆ {t}^{2}} = {Q}_{i} E + {\sum }_{i \neq j} \frac{{Q}_{i} {Q}_{j}}{4 πɛ {R}_{ij}^{2}} - 3 π {D}_{i} η \frac{ⅆ {H}_{i}}{ⅆ t} & ( 4 )\end{matrix}$$

where Hᵢ is a location of a toner particle i, mᵢ is a mass of the toner particle i, a charge amount of the toner particle i, Qⱼ is a charge amount of a toner particle j, Dᵢ is a diameter of the toner particle i, and Rᵢⱼ is a distance between the toner particles i and j.

A motion of the toner moving from the developing roller 401 to the photosensitive body 1 across the development gap (G) in conditions defined by the forward bias voltage (Vf) and parameters, such as, the particle diameter or the charge amount of toner, will now be described. The motion of the toner particles can be determined using Equation 3.

In Equation 3, the viscosity of air is η=0.0000182 kg/m/s. The forward bias voltage (Vf) and the duration (Tf) thereof to develop a second toner color after the first color toner image has been formed on the photosensitive body 1 without contaminating the first color toner image can be derived using Equation 3. In the following description, for simplifying the explanation, only two color toners are mentioned: a first toner and a second toner. However, it should be understood that this description is used only for illustration purposes, and are not meant to limit the scope of the present general inventive concept. That is, the first color toner represents any already developed toner, and the second color toner represents any next to be applied toner.

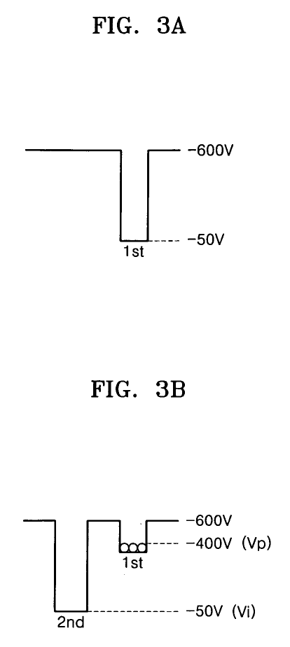

FIGS. 3A and 3B illustrate examples of surface potential profiles of the photosensitive body 1 used in Equation 3. In order to develop the first color toner image using the image forming apparatus illustrated in FIG. 1, the scorotron charger 2 charges the surface of the photosensitive body 1 with a uniform potential of −600 V. A potential of a first development region on the photosensitive body 1 scanned (illuminated or irradiated) by the exposing unit 3 becomes −50 V. A region not illuminated maintains the potential −600V. Whether a region is illuminated by the exposing unit 3 depends on image information of the first color. Accordingly, the surface potential profile of the photosensitive body 1 after the photosensitive body 1 is scanned by the exposing unit 3 is illustrated in FIG. 3A. The first color toner accommodated in the plurality of developing units 4 adheres to the first development region to generate the first color toner image on the photosensitive body 1.

Next, when the second color toner image is developed, the second color toner should not attach to the first color toner image already formed on an area of the photosensitive body 1 that is not the area to develop the second color toner thereon, and the first color toner image must not be separated from the photosensitive body 1 by an applied reverse bias voltage (Vb). By setting an appropriate grid voltage on the grid electrode 22, the scorotron charger 2 re-charges the photosensitive body 1 such that the potential of the first development region is in between the potential (−50 V) of the scanned portion and the potential (−600 V) of the non-scanned portion. The potential (Vp) of the first development region may be −400 V. The exposing unit 3 irradiates the light modulated according to image information about an image of the second color on the photosensitive body 1 such that the potential (Vi) of a second development region of the photosensitive body 1 on which the second color toner image will be developed becomes −50 V. The surface potential profile of the photosensitive body 1 after the exposing unit 3 has scanned the photosensitive body according to the image information of the second color is illustrated in FIG. 3B.

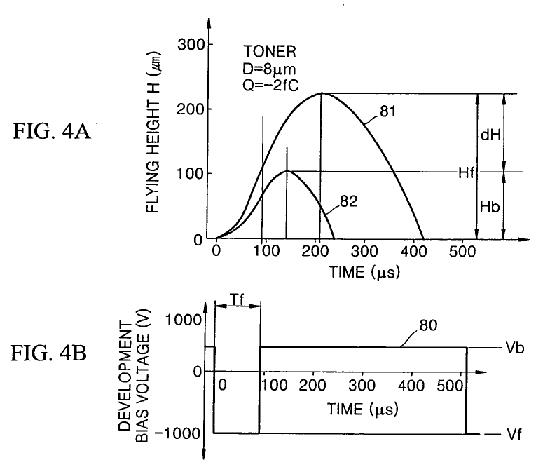

FIG. 4A is a graph illustrating toner particles motion (flying or transferring distance) between the developing roller 401 and the photosensitive body 1 of the apparatus of FIG. 1, and FIG. 4B is a graph illustrating a development bias voltage to be applied to the developing roller 401. A charge amount (Q) and a toner particle diameter (D) of the toner are −2 femto Coulomb (fC) and 8 micrometers (μm), respectively, and the development gap (G) has a width of 200 μm. As illustrated in FIG. 4B, the development bias voltage 80 includes the forward bias voltage (Vf) set to −1000 V, the reverse bias voltage (Vb) set to 400 V, and the duration of the forward bias voltage (Vf) set to 90 microseconds (μs), while a period of the development bias voltage (Vd) is set to 500 μs. The motion of toner particles (of the second toner) calculated using the above-mentioned values is illustrated in FIG. 4A

In FIG. 4A, a curve (line) 81 indicates a first flying height (distance) of toner particles moving from the surface of the developing roller 401 towards the photosensitive body 1 when the development bias voltage (Vd) corresponding to a curve (line) 80 has the time dependence illustrated in FIG. 4B and the potential (Vi) of the second development region is −50V. A curve (line) 82 indicates a second flying height of toner particles moving from the surface of the developing roller 401 to the photosensitive body 1 when the development bias voltage (Vd) has the time dependence illustrated in FIG. 4B and the potential (Vp) of the first development region is −400V.

As illustrated in FIG. 4A, the first flying distance of toner flying toward the first development region, Hb, is different from the second flying distance of the toner flying toward the second development region, Hf. With regard to the curve 81 in FIG. 4A, when the second development region faces a developing unit of the plurality of developing units 4 containing the second color toner, the second color toner can fly about 230 μm, and thus the second color toner can reach the second development region across the development gap (G), which is 200 μm. With regard to the curve 82 in FIG. 4A, when the first development region faces the developing unit containing the second color toner, the toner particles of the second color toner can fly only at 100 μm, and thus the toner particles of the second color toner can not reach the first development region. Due to a difference between the first and second flying distances dH=Hf−Hb, the toner particles of the second color toner can adhere to the second development region, without being attached to the first development region.

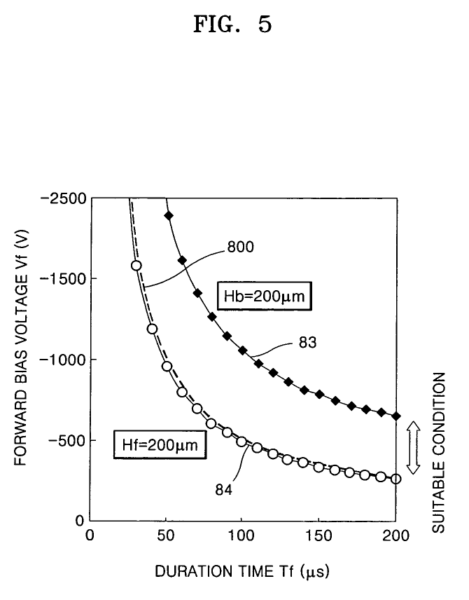

The development bias voltage (Vd) to accomplish the above-mentioned result will now be examined. FIG. 5 illustrates a graph of the forward bias voltage (Vf) versus the duration time (Tf) of the forward bias voltage when the toner can fly at 200 μm, which is the width of the development gap (G).

In FIG. 5, a curve (line) 83 indicates the forward bias voltage (Vf) versus the duration (Tf) thereof when the toner particles reach the first development region (that is, when the first flying distance Hb of FIG. 4 is equal to 200 μm). A curve (line) 84 indicates the forward bias voltage (Vf) versus the duration (Tf) thereof when the toner particles of the second color toner reach the second development region (that is, when the second flying distance Hf of FIG. 4 is equal to 200 μm). If a point defined by the forward bias voltage (Vf) and the duration (Tf) is below the curve 84, the second color toner cannot attached to the second development region because the flying distance is less than 200 μm. Also, if a point defined by the forward bias voltage (Vf) and the duration (Tf) is above the curve 83, the second color toner is attached to the first development region, thereby contaminating the first color toner image. Thus, if the development bias voltage (Vd) is set such that a point corresponding to the forward bias voltage Vf and the duration Tf is between the curves 83 and 84, the toner particles of the second color toner can only be attached to the second development region, without adhering to the first development region. A dotted line 800 in FIG. 5 represents an inversely proportional relationship between the forward bias voltage (Vf) and the duration (Tf) thereof. As illustrated in FIG. 5, the curve 800 and the curve 84 substantially overlap. Accordingly, to develop the second color toner on the second development region, the product of the forward bias voltage (Vf) and the duration (Tf) should be a constant (i.e., Vf×Tf=a constant). Hereinafter, whether any point defined by the forward bias voltage Vf and the duration Tf is available when the product of the Vf and the Tf is a constant will now be examined in greater detail.

FIG. 6 illustrates a graph of the forward bias voltage (Vf) versus the duration (Tf) thereof for specific values of the difference dH between the first flying distance (Hb) of the toner toward the first development region and the second flying distance (Hf) of the toner toward the second development region as illustrated in FIG. 4A. A dotted line (curve) 801 in FIG. 6 represents the inversely-proportional relationship between the forward bias voltage (Vf) and the duration (Tf) thereof. Thus, when the development bias voltage (Vd) corresponding to a point defined by a forward bias voltage (Vf) and a duration (Tf) on the curve 801 is applied to the developing roller 401, the flying distance of the second color toner is constant. FIG. 6 illustrates the curve 801 and curves corresponding to a plurality of constant values of the difference dH(=Hf−Hb). At a point (A) on the curve 801 where the forward bias voltage (Vf) and the duration (Tf) meet, the difference dH is about 200 μm. At a point (B) on the curve 801 where the forward bias voltage (Vf) and the duration (Tf) meet, the difference dH is between 250 μm and 300 μm. Along the curve 801 the difference dH increases as the forward bias voltage (Vf) and the duration (Tf) vary between the point (A) and the point (B). That is, the difference dH increases when an absolute value of the forward bias voltage (Vf) decreases and the duration (Tf) increases. Accordingly, if the development bias voltage (Vd) is set such that the absolute value of the forward bias voltage (Vf) is small and the duration (Tf) is long while satisfying the condition of “Vf×Tf=a constant”, the probability that the first color toner image already formed on the photosensitive body 1 is contaminated by the second color toner is reduced.

In FIG. 6, curves corresponding to the plurality of constant differences dH are discontinued in a graph region where the absolute value of the forward bias voltage (Vf) is less than 400 V. This is because, when the absolute value of the forward bias voltage is less than 400 V, an electric force generated by a development electric field acting on the toner is smaller than other forces which keep the toner is attached to the developing roller 401 (e.g., van der Waals's force, an image force, etc.) and thus the toner cannot be separated from the developing roller 401. According to results of non-contact developing experiments, toner was detached from the developing roller 401 and directed toward the photosensitive body 1 when the intensity of a development electric field was greater than 1˜2 V/μm. A development bias voltage (Vd) corresponding to the above limit for the intensity of the development electric field is referred to as a development starting voltage. When using a DC bias voltage as the development bias voltage (Vd), a sufficient development amount enough toner particles reach the photosensitive body 1 can be obtained by moving the sufficient toner to the photosensitive body 1 when a DC bias voltage having an absolute value that is 200-500 V larger than the development starting voltage is applied. When an AC bias voltage is used as the development bias voltage (Vd), the forward bias voltage (Vf) and the duration (Tf) may be determined such that the absolute value of the mean voltage of the AC bias voltage is about 200˜500 V larger than the absolute value of the development starting voltage. In the above discussion, conditions for developing the second color toner image while having a sufficient image density and without contaminating the first color toner image already formed on the photosensitive body 1 have been described. Under these conditions, when toner particles having uniform diameters and uniform charge amounts are used, a good developing result can be obtained.

As can be seen from Equation 3, since toner having a large charge amount or toner particles of a small particle diameter can easily respond to the development electric field and thus the flying distance of the toner particles moving from the developing roller 401 to the photosensitive body 1 is large, the first color toner image already formed on the photosensitive body 1 is likely to be contaminated by the toner particles of the second color toner. On the other hand, since the flying distance of toner having a small charge amount or having toner particles of a large particle diameter is small, the toner are less likely to contaminate the first color toner image already formed on the photosensitive body than when the toner particles have a large charge amount or a small particle diameter. Accordingly, conditions to develop the second color toner image without contaminating the first color toner image already formed on the photosensitive body 1 will now be examined considering a toner charge distribution and a toner particle diameter distribution of the toner (i.e., a charge-diameter distribution).

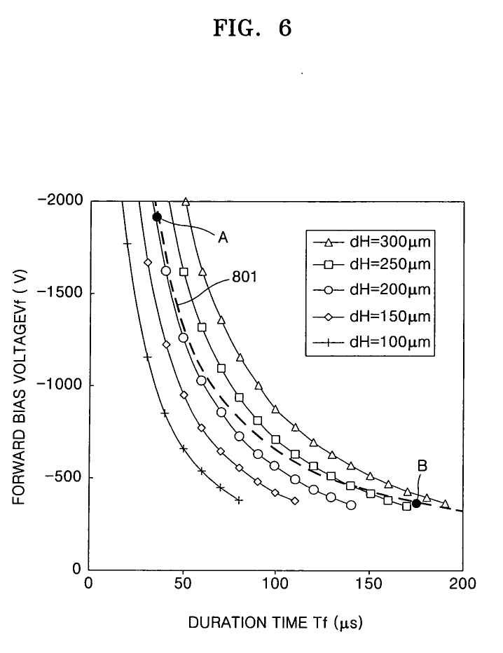

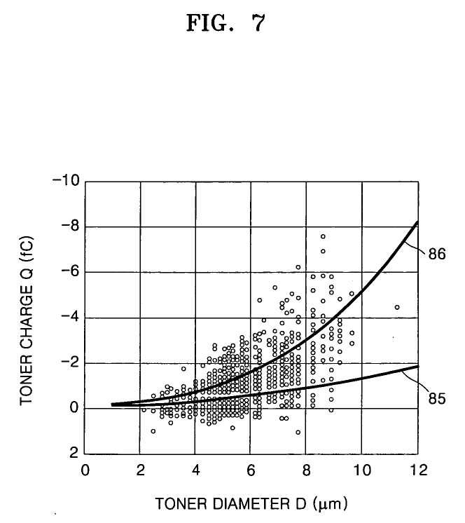

FIG. 7 is a graph illustrating the charge-diameter distribution of toner particles as measured by an E-Spart analyzer (product name of HOSOKAWA MICRON Corporation) used to determine the conditions to develop the second color toner without contaminating the first color toner image. In FIG. 7, points indicate data obtained by measuring charge amounts and diameters of about 3000 toner particles.

A curve 85 in FIG. 7 indicates the development limit charge amount Q_{DL} of a toner particle depending on a diameter of the toner particle. A curve 86 in FIG. 7 indicates the contamination limit charge amount Q_{CL} of a toner particle depending on the diameter of the toner particle. The development limit charge amount (Q_{DL}) represents a minimum charge amount of a toner particle so that the toner particle can be separated from the developing roller 401 and attached to the electrostatic latent image formed on the photosensitive body 1 when the development bias voltage (Vd) is applied. The development limit charge amount (Q_{DL}) can be obtained, for example, using Equation 2. The variables in Equation 2 include the diameter of the particle (D), the forward bias voltage (Vf), the duration (Tf) of Vf, the reverse bias voltage (Vb), the width of the development gap (G), the first potential (Vp) of the first region in which the first toner image is already developed on the photosensitive body 1, and the second potential (Vi) of the second region in which toner images will be developed on the photosensitive body 1. The contamination limit charge amount (Q_{CL}) represents a minimum charge amount of a toner particle that can adhere to the first region on the photosensitive body 1 occupied by the first toner image when the development bias voltage (Vd) is applied, that is, the toner particle that can contaminate the first toner image. The contamination limit charge amount (Q_{CL}) can be obtained, for example, by solving Equation 1. The variables in Equation (1) include the diameter (D) of the toner particle, the forward bias voltage (Vf), the duration (Tf) of Vf, the reverse bias voltage (Vb), the width of the development gap (G), and the first potential (Vp) of the first region in which the toner is already formed on the photosensitive body 1.

In FIG. 7, an upper region above the curve 85 corresponds to correlated ranges of the charge amount and the particle diameter of toner particles that can be used to develop the second color toner image. That is, if the absolute value of the charge amount of toner particles which adhere to the surface of the developing roller 401 is above the curve 85 (indicating the development limit charge amount Q_{DL}), the toner particles can cross the development gap (G) and a sufficient image density can be obtained. Also, a lower region below the curve 86 corresponds to correlated ranges of the charge amount and the particle diameter of toner particles which do not contaminate the first color toner image. That is, if the absolute value of the charge amount of toner particles which adhere to the surface of the developing roller 401 is below the curve 86 (indicating the contamination limit charge amount Q_{CL}), the toner particles can not cross the development gap (G) so that the second color toner image can be developed without contaminating the first color toner image. Accordingly, a region between the curves 85 and 86 gives ranges of the charge amount and the particle diameter of toner particles that can develop the second color toner image without contaminating the first color toner image and while obtaining a sufficient image density.

In FIG. 7, a mean toner particle diameter (i.e., a result obtained by dividing the total sum of the diameters of toner particles by the number of toner particles) is 5.4 μm and the mean charge amount (i.e., a result obtained by dividing the total sum of the charge amounts of the toner particles by the number of toner particles) is 0.7 fC. The mean charge amount and the mean particle diameter correspond to a point between the curve 85 and the curve 86 in FIG. 7. However, as illustrated in FIG. 7, 5% of the total toner particles belong to the upper region above the curve 86, and 49% of the total toner particles belong to the lower region below the curve 85. Accordingly, when toner particles having the charge-diameter distribution of toner particles illustrated in FIG. 7 are used, the first color toner image is contaminated by the second color toner. Also, a sufficient image density cannot be obtained due to insufficientamount of the second color toner developed (i.e., crossing the developing gap G).

A motion of toner particles of which charge amounts and diameters are not constant and which form a predetermined charge-diameter distribution was examined by computer simulation. The basic formula for the computer simulation is expressed by Equation 4.

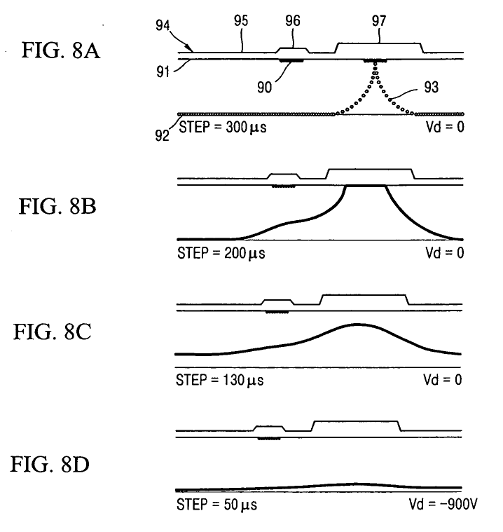

Equation 4 is obtained by considering the Coulomb force between toner particles besides the electric and viscosity forces considered in Equation 3. To simulate Equation 4 for a collection of toner particles first the width of the development gap (G), the surface potential (Vpc) distribution of the photosensitive body, the charge-diameter distribution of the toner particles, the initial arrangement of the toner particles (e.g., the distance between adjacent toner particles or the number of toner particles initially arranged in the first development region), and the development bias voltage (Vd), etc., are input in a simulation program. Since the potential distribution of toner adhered to the surface of the developing roller 401 and the photosensitive body 1, and the potential distribution of the surface of the photosensitive body 1 are changed due to rotations of the photosensitive body 1 and the developing roller 401, the motions of the potential distributions is considered when simulating toner particles motion using Equation 4. Then, an electric field of the development gap (G) (the first right term of Equation 4) and the Coulomb force between the toner particles (the second right term of Equation 4) are calculated. The flying trace of toner particles is calculated using Runge-Kutta formula and the calculated flying trace is recorded. In this process, the flying trace of toner moving from the developing roller 401 to the photosensitive body 1 (i.e., in a forward direction) or in the opposite direction (i.e., in a reverse direction) through the development gap (G) is calculated using Equation 4. When location of the toner particle according to the calculated result exceeds the surface of the photosensitive body 1 (when the toner particle flies in the forward direction) or has a value outside the surface of the developing roller 401 (when the toner flies in the reverse direction), the location of the toner particle is corrected to be on the surface of the photosensitive body 1 or the surface of the developing roller 401. Since this calculation should be widely known to one of ordinary skill in the computer simulation, a detailed description thereof is not provided herein. The simulation process is repeated using a predetermined period. The calculated locations of the toner particles within the development gap (G) versus time is illustrated in FIGS. 8A, 8B, 8C and 8D.

Simulation results illustrated in FIGS. 8A, 8B, 8C and 8D correspond to input values in which the charge amount of the toner is a constant (i.e., −2 fC), and the diameter of the toner particles is also a constant (i.e., 8 μm). FIGS. 8A, 8B, 8C and 8D have same elements and correspond to simulation results after 300 μs, 200 μs, 130 μs, and 50 μs, respectively. A lower line in FIGS. 8A, 8B, 8C and 8D represents a surface 92 of the developing roller 401 (all toner particles adhere initially to the surface of the developing roller 401). An intermediate line in FIGS. 8A, 8B, 8C and 8D represents a surface 91 of the photosensitive body 1. The width of the development gap G (i.e., a distance between the surfaces 91 and 92) is 200 μm. An upper line profile in FIGS. 8A, 8B, 8C and 8D represents a potential 94 on the surface 91 of the photosensitive body 1. A potential 95 of a background of an image is −600 V. A first potential 96 in the first development region in which a toner image is already formed is −350 V. Ten toner particles 90 of the first toner are arranged in the first development region having the first potential 96. A second potential 97 of the second development region which is illuminated by the exposing unit 3 so that another toner image to be developed thereof is −50 V. Toner particles 93 of the second toner are represented by dots that may form by overlapping a thick line. The development bias voltage (Vd) was set such that the forward bias voltage (Vf) is −900 V the duration is 90 μs, the reverse bias voltage (Vb) is 0 V, and the period is 500 μs. Two hundred toner particles 93 were initially arranged on the surface 92 of the developing roller 401 at an interval of 10 μm. A sequence of calculations is performed using a calculating time interval of 1 μs. The locations of the toner particles 93 when the time elapses by 50, 130, 200, and 300 μs are illustrated in FIGS. 8D, 8C, 8B and 8A, respectively. After 50 μs (FIG. 8D), the development bias voltage (Vd) is −900 V, which is equal to the forward bias voltage (Vf), and creates a direct electric field accelerating the toner particles 93 towards the surface 91 of the photosensitive body 1. Accordingly, the toner particles 93 are separated from the surface 92 of the developing roller 401 and fly toward the surface 91 of the photosensitive body 1. Since a direct electric field between the developing roller and of the second development region having the second potential 97 on the surface 91 of the photosensitive body 1 is stronger than direct electric fields in other regions (i.e., the background region having the potential 95 and the first development region having the first potential 96), the toner particles 93 that fly toward the second development region having the second potential 97 have a high rate in acceleration than that of the toner particles in the other regions and thus the toner particles 93 rapidly reach the second development region having the second potential 97. After 130, 200, and 300 μs, the development bias voltage (Vd) is 0 V, which is equal to the reverse bias voltage (Vb), and thus creates a reverse electric field accelerating the toner particles 93 back to the surface 92 of the developing roller 401. However, when the reverse electric field is applied after 90 μs, the toner particles 93 have a turn-field initial speed to fly toward the surface 91 of the photosensitive body 1, and therefore the toner particles may still reach the surface 91 of the photosensitive body 1, particularly in the second development region having the second potential 97. Since the toner particles 93 flying toward the first development region having the first potential 96 or the background region having the potential 95 fly at a low rate in acceleration than the toner particles 93 flying toward the second development region having the second potential 97 when the direct field (the forward bias voltage Vf) is applied, these toner particles have a smaller turn-field initial speed, and therefore the toner particles 93 flying toward the first development region having the first potential 96 or the background region having the potential 95 are slowed down and returned to the surface 92 of the developing roller 401 when applying the reverse field (the reverse bias voltage Vb). Therefore, the toner particles 93 are used to develop only the second development region having the second potential 97, without adhering to the first development region having the first potential 96.

However, since an actual toner is not comprised of toner particles having uniform charge amounts and uniform particle diameters but has a particle charge-diameter distribution as in FIG. 7, the actual developing process is different from the ideal process illustrated in FIGS. 8A, 8B, 8C and 8D. Results of computer simulations of a development process in which toner particles correspond to a predetermined charge-diameter distribution will be described.

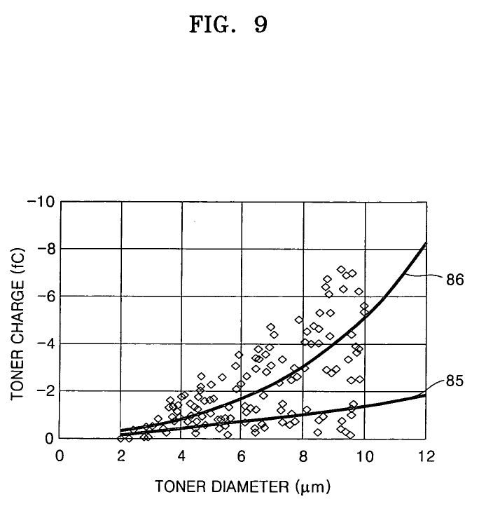

First, a computer simulation for a toner that has a wide charge-diameter distribution of toner particles is examined. FIG. 9 illustrates the wide charge-diameter distribution of the toner particles used in simulation. For two hundred toner particles, values of charge amount and particle diameter are generated according to the wide charge-diameter distribution illustrated in FIG. 9. Curves 85 and 86 in FIG. 9 have same significance as the curves 85 and 86 described while referring to FIG. 7. Some toner particles belong to a lower region below the curve 85 and some toner particles belong to an upper region above the curve 86. Hence, toner particles of the second color toner may contaminate the first color toner image already formed on the photosensitive body 1.

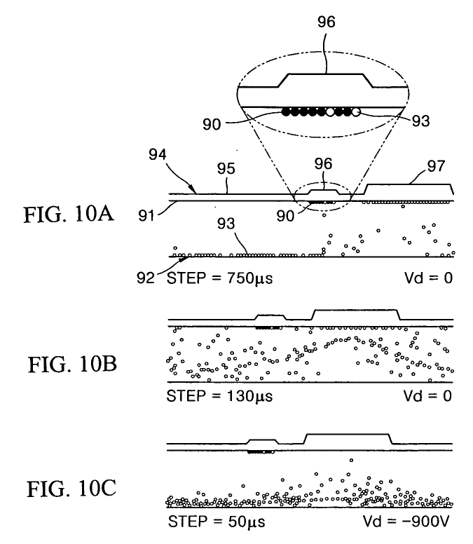

FIGS. 10A, 10B, 10C, and 10D illustrate results of a motion simulation for toner particles having the charge-diameter distribution of FIG. 9. Locations of the toner particles when the time elapses by 50, 130 and 750 μs are illustrated in FIGS. 10C, 10B, and 10A, respectively. Elements of FIGS. 10A-C are similar to the elements of FIGS. 8A-8D and same references indicate the same elements. Comparing the results illustrated in FIGS. 10A-10C with the results illustrated in FIGS. 8A-8D, it can be noted that the toner particles fly irregularly according to the simulation illustrated in FIGS. 10A-10C. When the time elapses by 130 μs (see FIG. 10B), some toner particles 93 of the second toner reach the background region having the potential 95 on the surface 91 of the photosensitive body 1. When the time elapses by 750 μs, it can be seen from the enlarged view of the first development region having the first potential 96 that toner particles 93 of the second color represented by the empty circles are mixed with toner particles 90 of the first color represented by the solid black circle, and thereby generate color contamination.

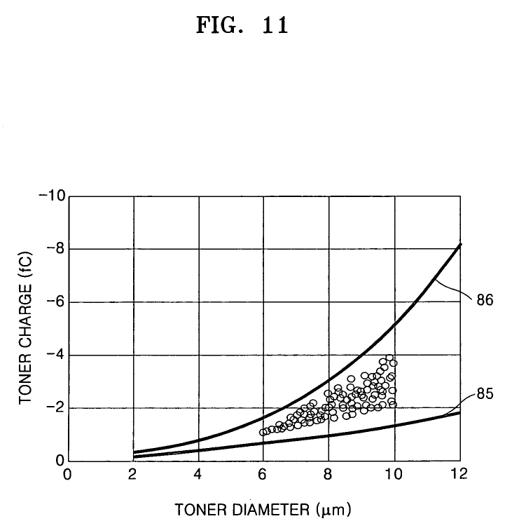

Next, a computer simulation of development for a toner that has a narrow charge-diameter distribution of toner particles is examined. FIG. 11 illustrates the narrow charge-diameter distribution of toner particles used in the computer simulation. For two hundreds toner particles, values of charge amounts and particle diameters are generated according to the narrow charge-diameter distribution illustrated in FIG. 11. Curves 85 and 86 in FIG. 11 have same significance as the curves 85 and 86 described while referring to FIG. 7. No toner particles belong to a lower region below the curve 85 and no toner particles belong to an upper region above the curve 86. Hence, the first color toner image already formed is likely not contaminated by toner particles of the second color toner.

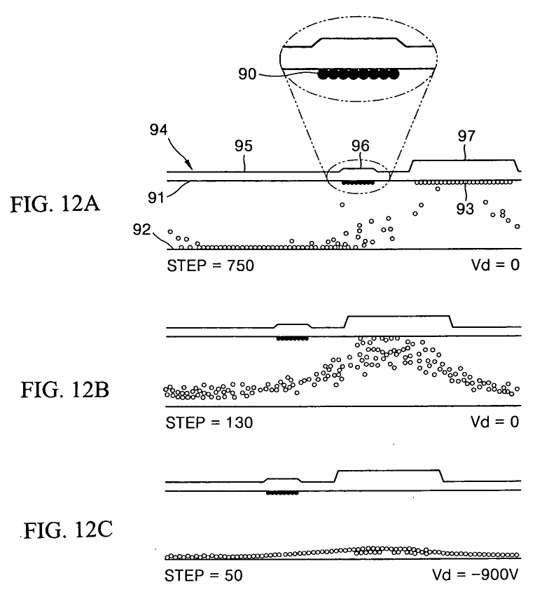

FIGS. 12 A, 12B and 12C illustrate results of a motion simulation for toner particles (i.e., the development process) having the charge-diameter distribution illustrated in FIG. 11. Elements of FIGS. 12A-C are similar to the elements of FIGS. 8A-8D and 10A-C and same references indicate the same elements. Locations of the toner particles when the time elapses by 50, 130 and 750 μs are illustrated in FIGS. 12C, 12B and 12A, respectively. Comparing the results illustrated in FIGS. 12A-12C with the results illustrated in FIGS. 10A-10C, it can be noted that toner particles are uniformly arranged according to the simulation illustrated in FIGS. 12A-12C. When the time elapses by 130 μs (see FIG. 12B), many toner particles 93 of the second toner fly toward the second development region having the second potential 97 and toner particles 93 flying toward the first development region having the first potential 96 or the background region having the potential 95 do not cross the development gap (G). When the time elapses by 750 μs, it can be seen from the enlarged view of the first development region having the first potential 96 that the first development region contains only the toner particles 90 of the first color represented by the solid black circle and there is no color contamination generated due to the toner particles 93 of the second color.

As mentioned above, in order to develop the second color toner image with a sufficient image density without contaminating the toner image already formed on the photosensitive body 1, toner particles of the second color toner should have a charge-diameter distribution of toner particles that fits between the curve 86 and the curve 85. To verify this, a non-contact developing experiment using one-component toner having a charge-diameter distribution of the toner particles that fit between the curve 86 and the curve 85 was performed using a modified multicolor image forming apparatus CLP-500 (product of SAMSUNG Electronics). However, although a physical property (for example, the content of charge control agent (CCA) of toner was adjusted or a development condition of the image forming apparatus was adjusted (for example, the curve 85 or the curve 86 was moved on the graph of FIG. 7 or 9), the charge-diameter distribution of the toner particles could not be fit only between curve 86 and curve 85.

Accordingly, the relationship between a percentage of toner particles that have charge amount and diameter combinations represented by points outside the region between the curve 86 and the curve 85 and color contamination was examined. Concretely, when the development condition was fixed (i.e., the curve 86 and the curve 85 were fixed), the charge-diameter distribution of toner particleswere changed to change the percentage of the toner particles that escape from the above region and have charge amount and diameter combinations represented by points outside the region between the curve 86 and the curve 85. Also, when the particle charge-diameter distribution of the toner was fixed, the percentage of the toner particles that escape from the above region and have a charge amount and diameter combinations represented by points outside the region between the curve 86 and the curve 85 was changed by changing the development condition, that is the contamination limit charge amount (Q_{CL}) illustrated by the curve 86 and the development limit charge amount (Q_{DL}) illustrated by the curve 85. In addition, in order to assess a degree of color contamination, an area percentage of an entire area of a color-contaminated image occupied by an area of the toner that causes the contamination was calculated. The area percentage can be obtained by an image analyzing apparatus or image analyzing software. To calculate the area percentage, the contaminated image was photographed using a charge-coupled device (CCD) camera to generate a photographed image. The contamination-causing toner was extracted from the photographed image, and the number of pixels of the contamination-causing toner was counted. By dividing the number of pixels of the contamination-causing toner with a total number of pixels of the photographed image, the degree of color contamination was obtained. In this examination, colors of contaminated toner and contamination-causing toner were set to yellow and black, respectively, so that only the contamination-causing toner can be exactly extracted. An image analyzing software for analyzing the area percentage, Optimas (product name of MEDIA CYBERNETICS) is used. Alternatively, the image analyzing apparatus, LUZEX (product name of NIRECO Corporation) may be used.

According to the above described method, an allowable degree of color contamination was established by a visual evaluation. The allowable degree of color contamination was assessed as an area percentage of 6%. The percentage of the toner particles that have charge amount and diameter combinations represented by points belonging to the upper region above the curve 86 (as represented in a charge-diameter graph as illustrated in FIGS. 7, 9 and 11) was substantially 5%. The same was obtained when the toner features were changed and when the development condition was changed. Since the toner particles having charge amount and diameter combinations represented by points belonging to the upper region above the curve 86 do cause color contamination, the degree of color contamination is substantially determined by the percentage of toner particles belonging to the upper region above the curve 86. When the percentage of toner particles belonging to the upper region above the curve 86 is 5%, the degree of color contamination is actually slightly larger than the allowable degree of color contamination, that is, the area percentage of 6%. Simulation showed that this slight increase is due to the Coulomb force between toner particles that can act as a repulsive force so that even some toner particles having charge amount and diameter combinations represented by points belonging to a lower region below the curve 86 can adhere to the first development region.

Thus, for the multicolor image forming apparatus of FIG. 1 the degree of color contamination can be suppressed to be below the allowable degree of color contamination by using toner that has less than 5% toner particles having charge amount and diameter combinations represented by points belonging to a region above the curve 86, that is the contamination limit charge amount (Q_{CL}). Also, considering differences between physical properties (for example, charging properties) of different color toners, the development condition can be adjusted so that toner particles whose absolute values of charge amounts are bigger than the contamination limit charge amount (Q_{CL}) occupy less than 5% of the total toner supplied to cross the developing gap (G). In this case, the development bias voltage (Vd) may vary according to the physical properties of the color toner during the other developing processes after the first developing process.

As mentioned above, the image forming apparatus of FIG. 1 suppresses the degree of color contamination (which contamination occurs during development of color toner images on the photosensitive body 1) to be below the allowable degree of color contamination and ensures an amount of development sufficient to obtain a desired image density, by using toner having a predetermined percentage of toner particles having a charge-diameter distribution in between the curves 86 and 85, or by adjusting the development condition (that is, the curve 85 and the curve 86). The basis of these advantages is described above using analysis and simulation. A charge-diameter distribution of toner particles for the analysis and the simulation is measured using the E-Spart analyzer. The E-Spart analyzer can simultaneously measure the charge amounts of the toner particles and the diameters thereof by measuring motions of the toner particles due to air vibration and an electric field in the air using a laser Doppler method. Since the charge amounts and the diameters are measured from the toner particles which fly in the air, the motions of the toner particles flying across the development gap (G) for a non-contact development can be almost accurately estimated from the measured charge amounts and diameters of the toner particles.

In the present embodiment as illustrated in FIG. 1, the interval (distance) between the photosensitive body 1 and the developing roller 401 of each of the developing units 4, i.e., the width of the development gap G, is 200 μm. The linear velocity of the photosensitive body 1 is 150 mm/s, and the linear velocity of the developing roller 401 of each of the developing units 4 is 150˜300 mm/s. Also, each of the developing units 4 is adjusted such that the developing roller 401 is coated with toner of a surface density of 0.8˜2.0 mg per 1 cm². A background potential of the photosensitive body 1 is −600 V. The potential (Vi) of an exposed region (second development region) is −50 V. The charging condition of the photosensitive body 1 for developments after the first color development is set such that the potential (Vp) of the first region on the photosensitive body 1 on which a toner image is already formed is −350 V. As described above, the charging condition can be set by adjusting the grid voltage applied to the grid electrode 22 of the scorotron charger 2. The development bias voltage (Vd) is set to a rectangular AC bias voltage such that the forward bias voltage (Vf) is −900 V and the duration (Tf) thereof is 90 μs, the reverse bias voltage (Vb) is 0 V, and the period is 500 μs.

Under these development conditions, the level of color contamination is suppressed to be below the allowable degree of color contamination by using toner having less than 5% toner particles whose charge-diameter distribution is above the curve 86. The charge-diameter distribution of the toner particles is measured by the E-Spart analyzer.

In addition to the above-described conditions, a toner having more than 45% toner particles having a charge-diameter distribution in between the curve 86 and the curve 85 (i.e., toner particles suitable for development) can be used. In addition, by adjusting the linear velocity of the developing roller 401, a sufficient amount of toner is developed on the photosensitive body 1 to obtain a target image density. Concretely, when the percentage of the toner particles suitable for the development is 45%, the linear velocity of the developing roller 401 is adjusted to be two times larger than that of the photosensitive body 1. Also, when the percentage of the toner particles suitable for the development is greater than 45%, the linear velocity of the developing roller 401 is adjusted so as to have an inversely proportional relationship with the percentage of the toner particles suitable for the development. For example, when the percentage of the toner particles suitable for the development is 60%, the linear velocity of the developing roller 401 is adjusted to be 1.5 times larger than that of the photosensitive body 1. In the above-mentioned conditions, the level of color contamination is suppressed to be below the allowable level, and the amount of toner that is developed on the photosensitive body 1 is sufficient.

According to another embodiment of the present general inventive concept, a toner having more than 6% toner particles whose charge-diameter distribution belongs to the upper region above the curve 86 is used under the development conditions described for the embodiment of FIG. 1, and a development bias voltage (Vd) in which the forward bias voltage (Vf) from is −800 V, the duration (Tf) thereof is 90 μs, and the reverse bias voltage (Vb) is −200 V is applied. Accordingly, the contamination limit charge amount (Q_{CL}) is newly set. Thus, the percentage of the toner particles having a charge-diameter distribution that is above the curve 86 becomes 4%, so that the degree of color contamination is suppressed to be below the allowable degree of color contamination.

Actually, in many cases, toners may have different particle charge-diameter distributions according to the color of toner. In these cases, the development conditions in this embodiment are adjusted such that the percentage of the toner particles having the charge-diameter distribution that is above the curve 86 is less than 5% to compensate for the difference between properties of toners of different colors.

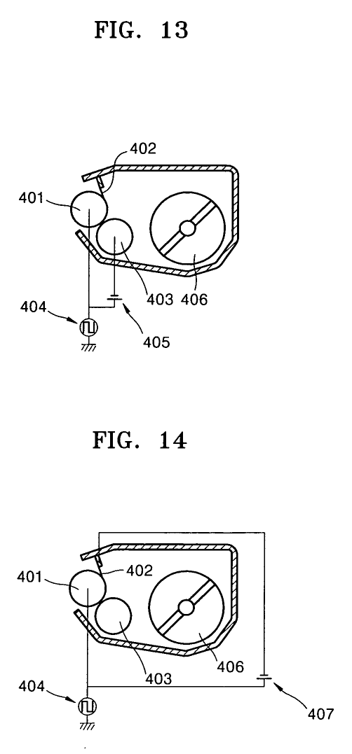

In the process of developing the embodiment of the present general inventive concept, it was found that overcharged toner (i.e., the toner of which the charge amount versus particle diameter is above curve 86) may cause of color contamination. According to another embodiment of the present general inventive concept, the toner overcharge is suppressed. For example, by adjusting a content of a charge controlling agent, the overcharge of the toner can be suppressed. However, if the overcharge of the toner is suppressed, the possibility that undercharged toner (i.e., the toner of which the particle diameter-charge amount is below curve 85) is generated increases. Further, reversely charged toner may be generated (for example, positively charged toner is generated in spite of negative charging). If an amount of toner which is undercharged or reversely charged is increased, the sufficient image density cannot be obtained. An embodiment of the developing unit 4 for supplying adequately charged toner on the developing roller 401 is illustrated in FIG. 13. Toner particles that do not have reverse polarity are referred to as toner particles having normal polarity.

FIGS. 13, 14, and 15 illustrate various embodiments of a developing unit and like elements have same references so that repeated descriptions are avoided. Referring to FIG. 13, the developing unit 4 includes the developing roller 401, a controlling member 402, a carrying roller 403, and an agitator 406. The developing roller 401 is charged by a power supply 404 to supply the development bias voltage (Vd) having an AC bias form. The controlling member 402 is in contact with the developing roller 401 with a predetermined contact pressure and controls the thickness of a toner layer coated (deposited) on the developing roller 401. The agitator 406 agitates a toner accommodated in the developing unit 4 such that the toner particles are rubbed with each other to be charged. The power supply unit 405 applies a voltage to the carrying roller 403 and the developing roller 401 to generate an electric field to move the toner from the carrying roller 403 to the developing roller 401. Since the toner particles are negatively charged in the present embodiment, the power supply unit 405 applies a negative voltage to the carrying roller 403 and the developing roller 401 to generate the electric field to move the negatively charged toner particles to the developing roller 401. Due to the electric field provided by the power supply unit 405, for example, the negatively charged toner particles fly toward the developing roller 401, but the reversely charged toner particles (i.e., positively charged toner particles) fly toward the carrying roller 403. Also, adequately charged toner particles fly toward the developing roller 401 faster than undercharged toner. Accordingly, since the adequately charged toner particles are selectively coated on the developing roller 401, the development efficiency increases, the color contamination can be prevented, and the sufficient image density can be obtained.

Referring to FIG. 14, the developing unit 4 according to another embodiment of the present general inventive concept includes a power supply unit 407 to apply a voltage to the controlling member 402 to generate an electric field that favors toner particles adhering to the developing roller 401. Since the toner is negatively charged in the present embodiment, the power supply unit 407 applies a negative voltage to the controlling member 402 to generate an electric field to favor the negatively charged toner adhering to the developing roller 401. Due to the electric field provided by the power supply unit 407, for example, the negatively charged toner attach to the developing roller 401 well, but the reversely charged toner (the positively charged toner) is separated from the developing roller 401. Also, the undercharged toner is adequately charged by the negative voltage provided by the power supply unit 407 and the rubbing with the controlling member 402. Accordingly, the adequately charged toner is coated on the developing roller 401, and thus the development efficiency is increased, the color contamination can be prevented, and the sufficient image density can be obtained.

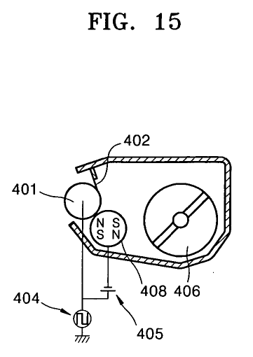

In order to reduce the percent of undercharged toner particle and reversely charged toner particle, a process mixing toner particle and a carrier to form a toner is performed according to another embodiment of the present inventive concept. A core material of the carrier may be magnetite, ferrite and iron. Also, according to the present embodiment, a surface of the core material of the carrier is coated with resin. If a conductive material, such as carbon black, is added to the coating resin, the overcharge can be suppressed and thus a better toner charging can be achieved. Referring to FIG. 15, the developing unit 4 includes a magnet roller 408. The toner particle and the carrier are mixed in the developing unit 4. The toner may include other components than the toner particles and the carrier. By agitating the toner particle and carrier using the agitator 406, the toner particle is charged by rubbing it with the carrier. The carrier charges the toner particle to supply the charged toner to the developing roller 401, but the carrier is not transferred on the photosensitive body 1. The toner particles adhere to the surface of the carrier. Since the carrier is magnetized, it adheres to the magnet roller 408. The power supply unit 405 applies a voltage to the magnet roller 408 to generate an electric field to favor the toner particles flying from the magnet roller 408 to the developing roller 401. Since the toner particles are negatively charged in the present embodiment, the power supply unit 405 applies a negative voltage to the magnet roller 408 to generate the electric field to favor the negatively charged toner particles flying to the developing roller 401. Thus, the adequately charged toner adhere to the developing roller 401, so that the color contamination can be reduced and the sufficient image density can be obtained.

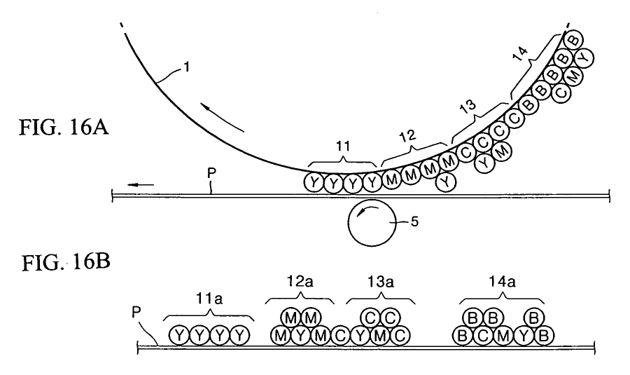

In order to overlap and develop the cyan (C), magenta (M), yellow (Y) and black (B) color toners to form a multicolor image, the black (B) toner having the lowest light reflectivity is first developed and the yellow (Y) toner having the highest light reflectivity is last developed on the photosensitive body 1 according to another embodiment of the present general inventive concept. That is, a development operation of overlapping different toner images on the photosensitive body 1 is performed in a first order of black (B), cyan (C), magenta (M) and yellow (Y) or in a second order of black (B), magenta (M), cyan (C) and yellow (Y). Although color contamination is always generated, the development operation in the above specified first and second orders reduces a degree to which color contamination is perceived. Referring to FIG. 16A, the reason why the degree of the color contamination perception is reduced will be described using the case where the development operation is performed in the first order of black (B), cyan (C), magenta (M) and yellow (Y) to form the multicolor toner image. Regions 11, 12, 13, and 14 in FIG. 16A are regions of the photosensitive body 1 on which the toners of yellow (Y), magenta (M), cyan (C) and black (B) colors are developed, respectively. Since the yellow (Y) toner is last developed, the region 11 is not substantially contaminated by the other color toners. The region 12 (where the magenta (M) toner is developed) may be contaminated by the yellow (Y) toner, the region 13 (where the cyan (C) toner is developed) may be contaminated by the yellow (Y) toner and magenta (M) toner, and the region 14 (where the black (B) toner is developed) may be contaminated by the yellow (Y) toner, magenta (M) toner and cyan (C) toner (see FIG. 16A). When the multicolor toner image is transferred to the paper (P), the laminated order of the multicolor toner at the surface of the paper (P) is opposite to the laminated order of the multicolor toner on the photosensitive body 1 (see FIG. 16B). That is, the toner having low light reflectivity is located over a contaminating toner, so that the contaminating toner is not easily viewed.

As described above, the multicolor image forming apparatus according to various embodiments of the present general inventive concept reduces an unwanted color mixture, and develops a multicolor image having an appropriate image density.

According to the present embodiment of the present general inventive concept, color contamination can be suppressed to be below an allowable degree of color contamination by using toner having less than 5% toner particles having a charge-diameter distribution that is above a curve indicating contamination limit charge amounts.

Additionally, a sufficient image density can be obtained by using toner having more than 45% of toner particles having a charge-diameter distribution that is in between the curve for the contamination limit charge amounts and a curve for development limit charge amounts.

Moreover, a percentage of the toner particles having a charge-diameter distribution that is above the curve for the contamination limit charge amounts can be adjusted to less than 5% by adjusting the development conditions (that is, adjusting the development potential, the first potential, the second potential and the background potential), so that color contamination can be suppressed to be below the allowable level.

Furthermore, toner particles adequately charged with a normal polarity can fly toward a developing roller when providing an electric field between a carrying roller and a developing roller to deposit the toner on the developing roller. Accordingly, the color contamination can be prevented and a sufficient image density can be obtained.

Also, the toner particles adequately charged with a normal polarity can adhere to the developing roller when providing an electric field between a controlling member and the developing roller to favor the toner particles flying to the developing roller. Accordingly, color contamination can be prevented and a sufficient image density can be obtained.

Additionally, most of the toner particles are adequately charged with a normal polarity by mixing and agitating the toner particles and carriers. However, only the toner particles and not the carriers adhere to the developing roller when using a magnet roller to perform non-contact development, and therefore the color contamination can be prevented and the sufficient image density can be obtained.

Also according to the present embodiment, the color contamination can be perceived less by performing development of color toner images on the photosensitive body in a color order from a color having the lowest reflectivity to a color having the highest reflectivity.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A multicolor image forming apparatus to print a multicolor image by sequentially developing a plurality of latent images with toner to form a plurality of toner images of different colors on a photosensitive body and simultaneously transferring the toner images onto a transfer medium, the multicolor image forming apparatus comprising:
a plurality of developing units each including a developing roller located at a development gap from the photosensitive body to be coated with a toner accommodated therein on a surface thereof, and to supply the toner across the development gap to the photosensitive body to form at least a first toner image and a second toner image; and
a development power supply unit to apply a development bias voltage to developing rollers of the plurality of developing units, the developing bias voltage being a rectangular AC bias voltage in which a forward bias voltage and a reverse bias voltage alternate,
wherein a percentage of toner particles contained in the toner and having diameter-charge amounts greater than a contamination limit diameter-charge amount is less than 5% when the contamination limit diameter-charge amount is a lower limit of a charge amount of the toner particles depending on a diameter thereof so that the toner particles fly from the developing roller to a first region on the photosensitive body occupied by the first toner image, and the contamination limit diameter-charge amount is calculated using variables including the forward bias voltage, a duration of the forward bias voltage, the reverse bias voltage, a width of the development gap, and a first potential of the first region on the photosensitive body already occupied with the first toner image.

2. The apparatus according to claim 1, wherein a percentage of the toner particles of the toner having a diameter-charge distribution in between the contamination limit diameter-charge amount and a development limit diameter-charge amount is more than 45%, when the development limit diameter-charge amount is the lower limit of the charge amount of the toner particles depending on the diameter thereof, so that the toner particles fly from the developing roller to the photosensitive body, and the development limit diameter-charge amount is calculated using variables including the forward bias voltage, the duration thereof, the reverse bias voltage, the width of the development gap, the first potential of the first region on the photosensitive body already occupied with the first toner image, and a second potential of a second region on the photosensitive body where the second toner image is to be developed.

3. The apparatus according to claim 2, wherein the contamination limit diameter-charge amount and the development limit diameter-charge amount are calculated by:
$${Q}_{CL} = \frac{3 π D η G}{{E}_{p 2} ( {T}_{p 2} - {T}_{f} ) + {E}_{p 1} {T}_{f}}$$
$${T}_{p 2} = - \frac{m}{3 π D η} ln [ \frac{{E}_{p 2} exp ( - \frac{3 π {DT}_{f}}{m} )}{{E}_{p 2} - {E}_{p 1} ( 1 - exp ( - \frac{3 π {DT}_{f}}{m} ) )} ]$$
$${Q}_{DL} = \frac{3 π D η G}{{E}_{i 2} ( {T}_{i 2} - {T}_{f} ) + {E}_{i 1} {T}_{f}}$$
$${T}_{i 2} = - \frac{m}{3 π D η} ln [ \frac{{E}_{i 2} exp ( - \frac{3 π D η {T}_{f}}{m} )}{{E}_{i 2} - {E}_{i 1} ( 1 - exp ( - \frac{3 π D η {T}_{f}}{m} ) )} ] , respectively ,$$
where Q_{CL} is the contamination limit diameter-charge amount, Q_{DL} is the development limit diameter-charge amount, D is the diameter of the toner particle, m is a mass of the toner particle, η is a viscosity of air, G is the development gap width, Vf is the forward bias voltage, Vb is the reverse bias voltage, Tf is the duration of Vf, Vp is the first potential of the first region in which the toner image is already formed on the photosensitive body, Eₚ₁=(Vf−Vp)/G is a forward electric field generated between the developer roller and the first region in which the toner image is already formed on the photosensitive body, Eₚ₂=(Vb−Vp)/G is a reverse electric field generated between the developer roller and the first region in which the toner image is already formed on the photosensitive body, Vi is a second potential of the second region in which second toner particles are to be developed on the photosensitive body, Eᵢ₁=(Vf−Vi)/G is a forward electric field generated between the developer roller and the second region in which the second toner particles are to be developed on the photosensitive body, and Eᵢ₂=(Vb−Vi)/G is a reverse electric field generated between the developer roller and the second region in which the second toner particles will be developed on the photosensitive body.

4. The apparatus according to claim 3, wherein the forward bias voltage (Vf) is determined so that a mean voltage of the development bias voltage (Vd) is larger than a development start voltage by 200˜500 V, and the development start voltage is a minimum voltage applied the developer roller to generate an electric field between the developer roller to the photosensitive body that is strong enough to make the toner particles to fly from the developer roller to the photosensitive body.

5. The apparatus according to claim 2, wherein a linear velocity of the developing roller is two times larger than that of the photosensitive body, when the percentage of the toner particles having the diameter-charge amounts distribution in between the contamination limit charge amount and the development limit charge amount is 45%.

6. The apparatus according to claim 5, wherein the linear velocity of the developing roller is inversely proportional to the percentage of the toner particles having a charge diameter distribution in between the contamination limit charge amount and the development limit charge amount.

7. The apparatus according to claim 2, wherein each of the plurality of developing units further comprises:
a carrying roller which is rotated while facing the developing roller, and a voltage is applied to the carrying roller to generate an electric field to control the toner to be attached from the carrying roller to the developing roller.

8. The apparatus according to claim 2, wherein:
each of the plurality of developing units further comprises a controlling unit in contact with the developing roller to control a thickness of a toner layer of the toner attached to the developing roller; and
a voltage to generate an electric field to attach the toner to the developing roller is applied to the controlling unit.

9. The apparatus according to claim 2, wherein each of the plurality of developing units further comprises:
carriers to rub with and charge the toner particles; and
a magnet roller which is rotated while facing the developing roller and to which the carriers adhere so that only the toner particles and not the carriers are attached to to the developing roller.

10. The apparatus according to claim 9, wherein a voltage is applied to the magnet roller to generate an electric field to control the toner particles to be attached to the developing roller.

11. The apparatus according to claim 2, wherein:
the plurality of developing units include four developing units accommodating black, cyan, magenta and yellow toner, respectively; and
the black toner having the lowest light reflectivity is first developed on the photosensitive body and the yellow toner having the highest light reflectivity is last developed on the photosensitive body.

12. The apparatus according to claim 2, further comprising:
a charging unit to charge the photosensitive body with a uniform potential,
wherein the charging unit charges the photosensitive body such that the first potential of the region in which the first toner image is already formed on the photosensitive body is between a second potential of a second region on which second toner image is to be developed and a potential of a background region of the photosensitive body.

13. The apparatus according to claim 12, wherein the charging unit comprises a scorotron charger having a grid electrode.

14. A multicolor image forming apparatus to print a multicolor image by developing and overlapping a plurality of toner images of different colors on a photosensitive body and transferring the toner images onto a transfer medium, the multicolor image forming apparatus comprising:
a plurality of developing units each including a developing roller located at a development gap from the photosensitive body coated with respective toners accommodated therein on a surface thereof, and to supply the toners across the development gap to the photosensitive body to form a multicolor image having at least a first toner image and a second toner image; and
a development power supply unit to apply a development bias voltage to the developing rollers of the plurality developing units, the development bias voltage being a rectangular AC bias voltage in which a forward bias voltage and a reverse bias voltage alternate,
wherein the development bias voltage is determined such that a percentage of toner particles in the toners having diameter-charge amounts greater than a contamination limit diameter-charge amount of the toner particles is less than 5%, when the contamination limit diameter-charge amount is a lower limit of a charge amount of the toner particles depending on a diameter thereof, with respect to a limit of charge amount of second toner particles of the second toner image so that the toner particles adhere to a region on the photosensitive body occupied by the first toner image, and the contamination limit diameter-charge amount is calculated using variables including the forward bias voltage, a duration of the forward bias voltage, the reverse bias voltage, a width of the development gap, and a first potential of the first region on the photosensitive body already occupied with the first toner image.

15. The apparatus according to claim 14, wherein the contamination limit charge amount is calculated by:
$${Q}_{CL} = \frac{3 π D η G}{{E}_{p 2} ( {T}_{p 2} - {T}_{f} ) + {E}_{p 1} {T}_{f}}$$
$${T}_{p 2} = - \frac{m}{3 π D η} Ln [ \frac{{E}_{p 2} exp ( \frac{- 3 π D η {T}_{f}}{m} )}{{E}_{p 2} - {E}_{p 1} ( 1 - exp ( \frac{- 3 π D η {T}_{f}}{m} ) )} ]$$
where Q_{CL} is the contamination limit charge amount D is the diameter of the toner particle, m is a mass of the toner particle, q is a viscosity of air, G is the width the development gap, Vf is the forward bias voltage, Vb is the reverse bias voltage, Tf is the duration of Vf, Vp is the first potential of the first region, Eₚ₁=(Vf−Vp)G) is a forward electric field generated in the first region, and Eₚ₂=(Vb−Vp)G) is a reverse electric field generated in the first region.

16. A multicolor image forming apparatus to print a multicolor image by developing a plurality of toner images of different colors on a photosensitive body and transferring the toner images onto a transfer medium, the multicolor image forming apparatus comprising:
a plurality of developing units, each including a developing roller located at a development gap from the photosensitive body, to deposit a toner accommodated therein on a surface of the developing roller, and to supply the toner across the development gap to the photosensitive body to form a multicolor image including at least a first toner image and a second toner image; and
a development power supply unit to apply a development bias voltage to developing rollers of the plurality of developing units, the development bias voltage being a rectangular AC bias voltage,
wherein a percentage of toner particles in the toner having diameter-charge amounts greater than a contamination limit diameter-charge amount is less than 5%, the contamination limit diameter-charge amount being a limit charge amount of the toner particles depending on a diameter thereof so that the toner particles adhere to a region on the photosensitive body occupied by the first toner image using the development bias voltage.

17. The apparatus according to claim 16, wherein a percentage of the toner particles in the toner having the diameter-charge distribution in between the contamination limit diameter-charge amount and a development limit diameter-charge amount is more than 45%, the development limit diameter-charge amount being a limit charge amount of a toner particle depending on a diameter of the toner particle with respect to a limit of a charge amount of second toner particles of the second toner image so that the toner particles fly from the developing roller to an electrostatic latent image formed on the photosensitive body using the development bias voltage.

18. The apparatus according to claim 17, wherein a linear velocity of the developing roller is two times larger than that of the photosensitive body, when the percentage of the toner particles having the diameter-charge amounts distribution in between the contamination limit charge amount and the development limit charge amount is 45%.

19. The apparatus according to claim 18, wherein the linear velocity of the developing roller is inversely proportional to the percentage of the toner particles having the diameter-charge amounts distribution in between the contamination limit charge amount and the development limit charge amount.

20. The apparatus according to claim 17, wherein the development bias voltage comprises a forward bias voltage (Vf) which is determined so that a mean voltage of the development bias voltage (Vd) becomes greater than a development start voltage by 200˜500 V, and the development start voltage is a minimum voltage applied the developer roller to generate an electric field between the developer roller to the photosensitive body that is strong enough to make the toner particles to fly from the developer roller to the photosensitive body.

21. The apparatus according to claim 17, further comprising:
a charging unit to charge the photosensitive body with a potential such that the potential of the region in which the first toner image is already formed on the photosensitive body is between the potential of a region on which the second toner particles of the second toner image will be developed after the first toner image and a potential of a background region of the photosensitive body.

22. The apparatus according to claim 17, wherein:
the developing unit further comprises a carrying roller which is rotated while facing the developing roller and a controlling unit which is in contact with the developing unit to control a thickness of a toner layer of the toner adhering to the developing roller; and
a voltage to generate an electric field to control the toner particles to move from the carrying roller to the developing roller is applied to the carrying roller.

23. The apparatus according to claim 22, wherein a voltage to generate the electric field to attach the toner particles to the developing roller is applied to the controlling unit.

24. The apparatus according to claim 17, wherein:
the plurality of developing units comprise four developing units accommodating black, cyan, magenta and yellow color toner, respectively; and
the black color toner having the lowest light reflectivity is first developed and the yellow color toner having the highest light reflectivity is last developed.

25. The apparatus according to claim 21, wherein the developing unit further comprises:
carriers to rub with and charge the toner particles; and
a magnet roller which is rotated while facing the developing roller, onto which the carriers adhere, and to which a voltage is applied to generate an electric field to control the toner particles to be attached to the developing roller such that only the toner particles and not the carriers adhere to the developing unit.

26. A multicolor image forming apparatus to print a multicolor image by developing and overlapping a plurality of toner images of different colors on a photosensitive body and transferring the toner images onto a transfer medium, the multicolor image forming apparatus comprising:
a plurality of developing units each including a developing roller located at a development gap from the photosensitive body and coated with toners accommodated therein on a surface thereof, and to supply the toners across the development gap to the photosensitive body to form a multicolor image including at least a first toner image and a second toner image; and
a development power supply unit to apply a development bias voltage to the developing rollers of the developing units, the development bias voltage being a rectangular AC bias voltage,
wherein the development bias voltage is determined such that a percentage of particles of the toners having diameter-charge amounts greater than a contamination limit diameter-charge amount of the toner particles is less than 5%, wherein the contamination limit diameter-charge amount represents a limit charge amount of the toner particles depending on a diameter thereofwith respect to a limit of a charge amount of second toner particles of the second toner image so that the toner particles adhere to a region on the photosensitive body occupied by the first toner image.

27. A multicolor image forming apparatus comprising:
a photosensitive body to form a first color latent image; and
a developing unit spaced apart from the photosensitive body by a gap to develop the first color latent image with a toner having toner particles to form a first toner color image on a first region of the photosensitive body according to a first potential having a first forward bias voltage and a first reverse bias voltage,
wherein a portion of the toner particles having a diameter-charge amount greater than a contamination limit diameter-charge amount which is determined according to first variables having the forward bias voltage, a duration of the forward bias voltage, the reverse bias voltage, the gap, and a potential of the first region, is less than 5% with respect to a total amount of the toner particles of the toner.

28. The multicolor image forming apparatus according to claim 27, further comprising:
a second developing unit spaced apart from the photosensitive body by a second gap to develop a second color latent image formed in the photosensitive body with a second toner having second toner particles to form a second toner color image on a second region of the photosensitive body according to a second potential having a second forward voltage and a second reverse bias voltage;
wherein a portion of the second toner particles having a second diameter-charge amount between the contamination limit diameter-charge amount and a development limit diameter-charge amount which is determined according to the first variables and a second variable having the second potential applied to the second region is more than 45% with respect to a total amount of the second toner particles of the second toner.

29. The multicolor image forming apparatus according to claim 28, wherein a second portion of the second toner particles having the diameter-charge amount greater than the contamination limit diameter-charge amount is less than 5% with respect to a total amount of the second toner particles of the second toner.

30. The multicolor image forming apparatus according to claim 29, wherein the contamination limit charge amount is determined such that color contamination by the second toner particles on the first toner image formed on the first region is less than 5%.

31. The multicolor image forming apparatus according to claim 29, wherein the second toner image is formed after the first toner image has been formed, and light reflectivity of the first toner is lower than that of the second toner.

32. The multicolor image forming apparatus according to claim 27, wherein:
the development unit develops the first color latent image with the toner to form the first toner color image on the first region of the photosensitive body after another toner color image has been formed on another region of the photosensitive body according to another potential having another forward bias voltage and another reverse bias voltage; and
a second portion of the toner particles having a second diameter-charge amount between the contamination limit diameter-charge amount and a development limit diameter-charge amount which is determined according to the first variable and a second variable having the another potential is more than 45%.

33. The multicolor image forming apparatus according to claim 32, wherein the contamination limit diameter-charge amount is determined such that color contamination on the another region of the another toner color image by the first toner particles is less than 5%.

34. The multicolor image forming apparatus according to claim 33, wherein the first toner has light reflectivity higher than that of the another toner.

35. The multicolor image forming apparatus according to claim 32, wherein the first potential is determined such that contamination on the another region of the photosensitive body by the first toner particles is less than 5% when the first toner image is formed after the another toner image has been formed.
